(19) United States
(12) Patent Application Publication
(10) Pub. No.: US 2016/0349122 A1
(43) Pub. Date: Dec. 1, 2016

(54) APPLICATIONS OF MULTI-GRID STRAIN GAGES

(71) Applicant: Sikorsky Aircraft Corporation, Stratford, CT (US)

(72) Inventor: Eric Bogert, Waterbury, CT (US)

(21) Appl. No.: 15/160,040

(22) Filed: May 20, 2016

Related U.S. Application Data
(60) Provisional application No. 62/166,168, filed on May 26, 2015.

(51) Int. Cl. G01L 1/00

(52) U.S. Cl. CPC G01L 1/005

(57) ABSTRACT

A system for measuring or monitoring characteristics of a structure is provided. The system includes a first gage having a first grid and a second grid, the first and second grids configured to cover substantially the same area of a structure. A data console is configured in electrical communication with each of the first grid and the second grid of the first gage. The first grid of the first gage is configured to measure a first characteristic of the structure and the second grid of the first gage is configured to measure a second characteristic of the structure.

### CROSS-REFERENCE TO RELATED APPLICATION

This application is related to and claims the benefit of U.S. Provisional Patent Application Ser. No. 62/166,168 filed on May 26, 2015, the entire contents of which are herein incorporated by reference.

### BACKGROUND

The subject matter disclosed herein generally relates to strain gages and, more particularly, to multigrid gages configured to enable different characteristic measurements with a single sensor.

In many structural tests, a design analyst may need to validate analytical stress models with measured stress or strain data. For example, in aerospace applications various data may be collected from ground and flight test activities. In some instances, it may be desirable to know a particular characteristic at a particular location on a component. In traditional sensing systems, gages may be located substantially in the same place, but not actually in the same place. That is, when more than one characteristic is to be measured, a plurality of sensors may be located around or near an area of interest, but the precise location will not be the same for each sensor.

For example, in a prior configuration, the strain in a certain location on a component may be desired to be measured. However, the location of the desired strain measurement may already have a calibrated axial bridge, edgewise or normal bending bridge, or torsion bridge gage installed thereon. In alternative solutions two gages (sensors) may be stacked on top of each other. In either case, the measurements made by two different sensors may not accurately represent the characteristic at the exact location desired. This may lead to uncertainty in measurements and/or corrections to be made that may lead to additional uncertainty.

### SUMMARY

According to one embodiment a system for measuring or monitoring characteristics of a structure is provided. The system includes a first gage having a first grid and a second grid, the first and second grids configured to cover substantially the same area of a structure. A data console is configured in electrical communication with each of the first grid and the second grid of the first gage. The first grid of the first gage is configured to measure a first characteristic of the structure and the second grid of the first gage is configured to measure a second characteristic of the structure.

In addition to one or more of the features described above, or as an alternative, further embodiments may include a second gage having a first grid and a second grid configured to cover substantially the same area of the structure, the area of the second gage being different from the area of the first gage.

In addition to one or more of the features described above, or as an alternative, further embodiments may include that the first grid of the second gage is configured to measure a third characteristic of the structure and the second grid of the second gage is configured to measure a forth characteristic of the structure.

In addition to one or more of the features described above, or as an alternative, further embodiments may include that the first and third characteristics are the same.

In addition to one or more of the features described above, or as an alternative, further embodiments may include that the first grid of the first gage and the first grid of the second gage are electrically connected to form a circuit.

In addition to one or more of the features described above, or as an alternative, further embodiments may include that the data console is configured to form electrical circuits with the grids.

In addition to one or more of the features described above, or as an alternative, further embodiments may include a plurality of additional gages, the additional gages each having a first grid and a second grid.

According to another embodiment, a method of measuring or monitoring characteristics of a structure is provided. The method includes disposing a first gage having a first grid and a second grid on a surface of a structure, the first and second grids configured to cover substantially the same area of a structure, electrically connecting the first grid of the first gage into a first electrical circuit, electrically connecting the second grid of the first gage into a second electrical circuit, monitoring a first characteristic of the structure at a first area defined by the first gage, with the first electrical circuit, and simultaneously monitoring a second characteristic of the structure at the first area with the second electrical circuit.

In addition to one or more of the features described above, or as an alternative, further embodiments may include disposing a second gage at a second area, the second gage having a first grid and a second grid configured to cover the second area, the area of the second area being different from the first area, electrically connecting the first grid of the second gage into a third electrical circuit, and electrically connecting the second grid of the second gage into a fourth electrical circuit.

In addition to one or more of the features described above, or as an alternative, further embodiments may include monitoring a third characteristic of the structure at the second area, with the third electrical circuit, and monitoring a fourth characteristic of the structure at the second area with the fourth electrical circuit.

In addition to one or more of the features described above, or as an alternative, further embodiments may include that the first and third characteristics are the same.

In addition to one or more of the features described above, or as an alternative, further embodiments may include that the first grid of the first gage and the first grid of the second gage are electrically connected to form a circuit.

In addition to one or more of the features described above, or as an alternative, further embodiments may include that the first grid of the first gage is configured as part of one of a torsion gage, a flatwise bending gage, and an edgewise bending gage.

In addition to one or more of the features described above, or as an alternative, further embodiments may include disposing a plurality of additional gages on a surface of the structure wherein the additional gages each includes a first grid and a second grid.

Technical effects of embodiments of the present disclosure include gages with dual grids thereon, enabling measurement of characteristics of a structure at a single location, without the need to offset the physical location of gages that are configured to measure different characteristics.

### BRIEF DESCRIPTION OF THE DRAWINGS

The subject matter is particularly pointed out and distinctly claimed in the claims at the conclusion of the specification. The foregoing and other features and advantages of the present disclosure are apparent from the following detailed description taken in conjunction with the accompanying drawings in which:

FIG. 1 is an exemplary schematic of a gage in accordance with an exemplary embodiment of the present disclosure;

FIG. 2 is an exemplary schematic of an alternative configuration of a gage in accordance with an exemplary embodiment of the present disclosure;

FIG. 3A is a schematic illustration of a structure having multiple gages installed thereon, in accordance with an embodiment of the present disclosure;

FIG. 3B is a schematic diagram of an axial bridge indicating the configuration of the first grids of the gages of FIG. 3A in accordance with an embodiment of the present disclosure;

FIG. 3C is a schematic diagram of a bridge for total strain indicating the configuration of the second grids of the gages of FIG. 3A in accordance with an embodiment of the present disclosure;

FIG. 4A is a schematic illustration of a structure having multiple gages in accordance with an alternative embodiment of the present disclosure applied thereon;

FIG. 4B is a schematic diagram of an axial bridge indicating the configuration of the first grids of the gages of FIG. 4A in accordance with an embodiment of the present disclosure;

FIG. 4C is a schematic diagram of a half-bending bridge indicating the configuration of the second grids of the gages of FIG. 4A in accordance with an embodiment of the present disclosure;

FIG. 5A is a schematic illustration of a structure having multiple gages in accordance with an alternative embodiment of the present disclosure applied thereon;

FIG. 5B is a schematic diagram of a torsional bridge indicating the configuration of the first grids of the gages of FIG. 5A in accordance with an embodiment of the present disclosure;

FIG. 5C is a schematic diagram of a total strain bridge indicating the configuration of the second grids of the gages of FIG. 5A in accordance with an embodiment of the present disclosure;

FIG. 6A is a schematic illustration of a structure having multiple gages in accordance with an alternative embodiment of the present disclosure applied thereon;

FIG. 6B is a schematic diagram of a full bending bridge indicating the configuration of the grids of the gages of FIG. 6A in accordance with an embodiment of the present disclosure;

FIG. 6C is a schematic diagram of a total strain bridge indicating the configuration of the grids of the gages of FIG. 6A in accordance with an embodiment of the present disclosure;

FIG. 7A is a schematic illustration of a first side of a structure with a plurality of gages in accordance with embodiments of the invention installed thereon; and

FIG. 7B shows a second side of the structure of FIG. 7A with additional gages installed thereon.

### DETAILED DESCRIPTION

In accordance with embodiments of the present disclosure, a multi-grid gage is provided in a single sensor, thus enabling measurement of more than one characteristic of a structure at a single, precise location.

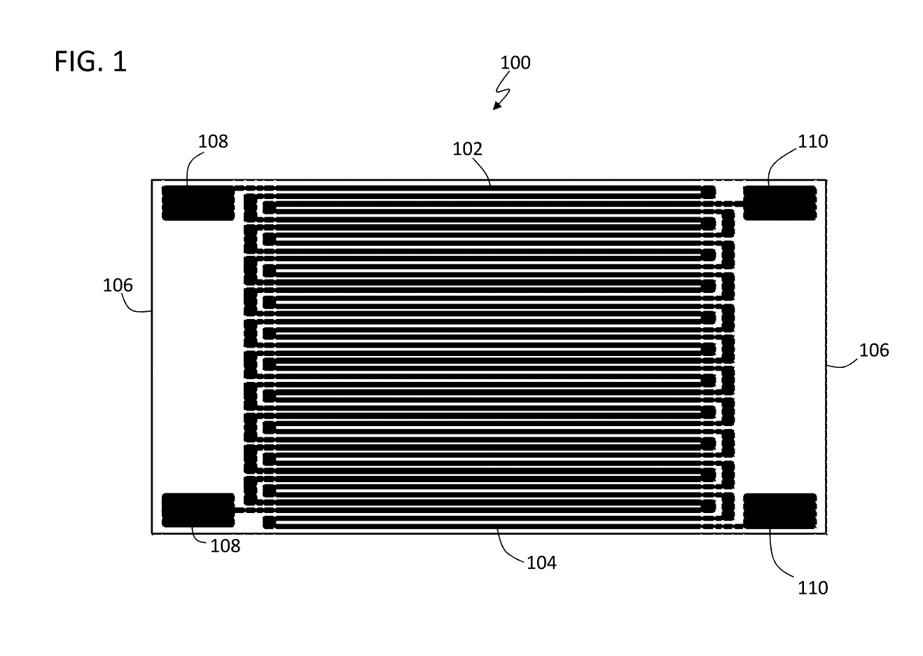

Turning to FIG. 1, an exemplary gage in accordance with an exemplary embodiment of the present disclosure is shown. Gage 100 has a first grid 102 and a second grid 104 covering essentially the same physical area, as indicated edge 106 of gage 100. As shown, the grids 102, 104 are aligned in the same direction. The grids 102, 104 are integrated within a single layer of the gage 100. Further, the first grid 102 defines a first dedicated measurement channel that is established when tabs 108 are connected to an electrical circuit. Similarly, the second grid 104 defines a second dedicated measurement channel that is established when tabs 110 are connected to an electrical circuit. Accordingly, embodiments of the present disclosure, such as shown in FIG. 1, enable for measuring two different characteristics of a structure simultaneously and at a single location. For example, both total strain or stress and a calibrated load or moment at one location using a single gage 100 with two separate channels is attainable.

In gage 100, linear pattern dual grids 102, 104 run integrated, i.e., between each other, so that the output (i.e. strain) from each channel is from essentially the same surface area or location on a structure. Thus, the area occupied by two different measurement sensors (grids 102, 104) is contained in the same space and thus the ability to measure multiple characteristics at a single, precise location is improved. Such gages may be small enough to accommodate both a total strain grid and an axial bridge grid and may, for example, be located on the neck of a rod end, which, as known in the art has a very small surface area. It can also be used on a structure such as tail rotor flex-beam, where both a corner strain measurement and a bending moment measurement are required. Dual grid linear pattern gages in accordance with embodiments of the present disclosure can also serve as backup gage/bridge channels on flight test aircraft, so that if a gage parameter fails, the backup gage parameter (i.e. same gage but a different grid) can be used instead. This would reduce lost flight time, versus removing the aircraft component from the flight test aircraft and re-gaging, re-calibrating, and re-installing the component. While discussed in the context of aircraft components, it is understood that aspects disclosed and discussed herein could be used in other types of machinery and structures where strains, moments, and other forces, impacts, etc. are measured or monitored.

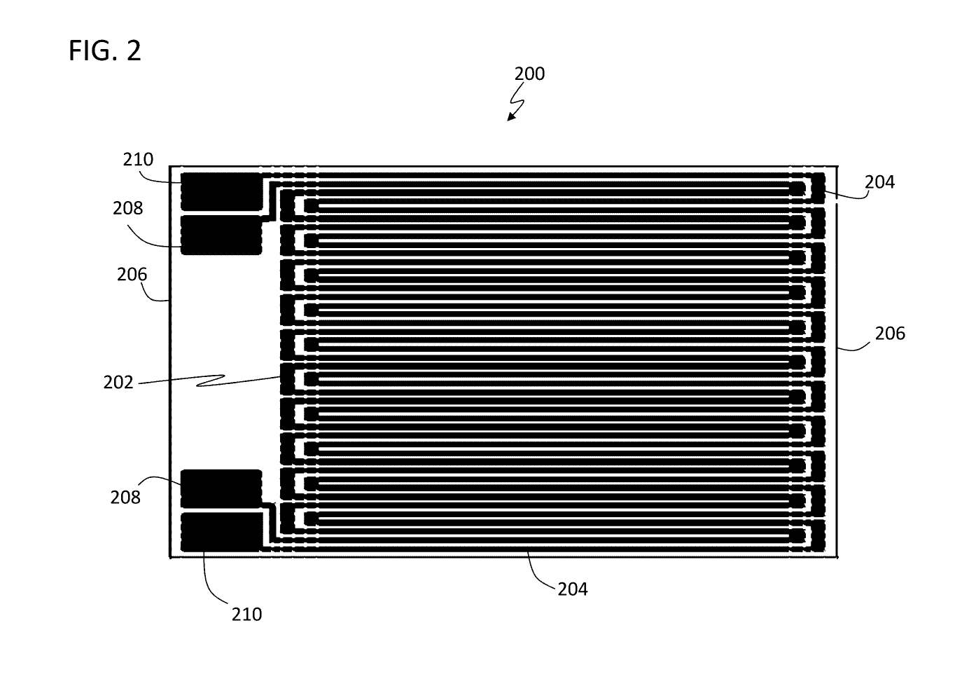

Turning now to FIG. 2, an alternative configuration of a gage in accordance with an exemplary embodiment of the present disclosure is shown. Gage 200 is substantially similar to gage 100 of FIG. 1. Gage 200 includes a first grid 202 and a second grid 204 which are both contained within edge 206 of gage 200. The primary different between gage 200 and gage 100 is the location of the tabs 208, 210. On gage 100, the tabs 108, 110 are located on opposite sides of the gage 100. However, on gage 200, tabs 208, 210 are located on the same side of the gage 200.

It will be appreciated that both gage 100 of FIG. 1 and gage 200 of FIG. 2 are provided for illustrative purposes, and variations may be made without departing from the scope of the present disclosure. For example, the gage and grid size and number of grid lines may be configured based on the desired application. However, in each embodiment, two or more grids are provided that cover the same surface area and are embedded and/or integrated into a single sensor/gage. Thus, an output from the sensors or gages may include two or more characteristics or measurements at a single location.

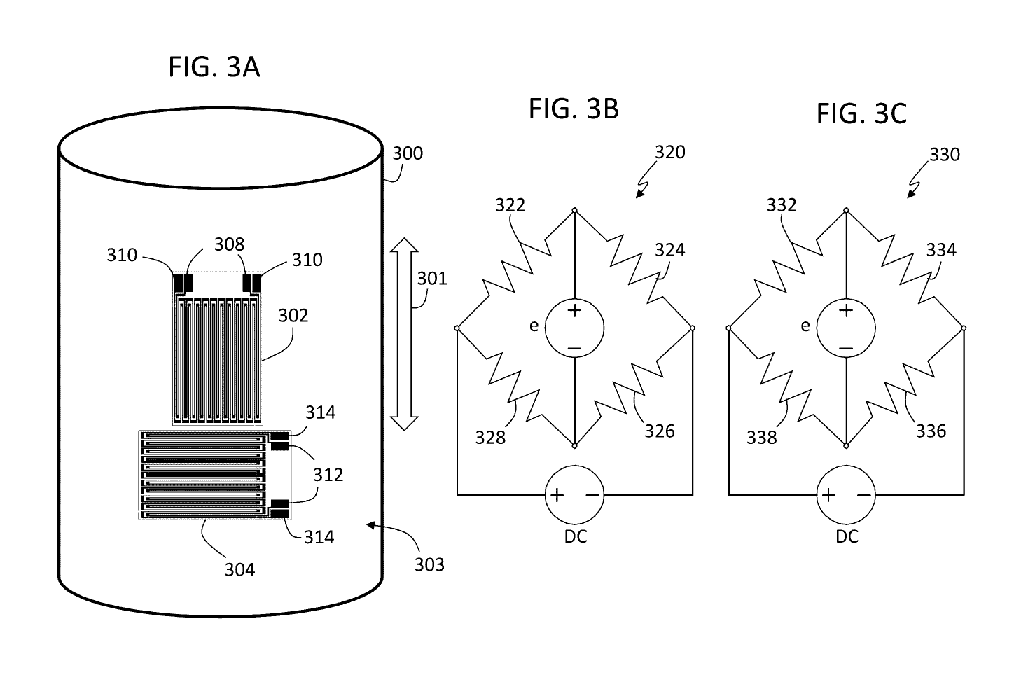

Turning now to FIGS. 3A-3C, an application employing multiple gages in accordance with an exemplary embodiment of the present disclosure is shown. FIG. 3A shows a schematic illustration of a structure having multiple gages in accordance with an embodiment of the present disclosure applied thereon. FIG. 3B is a schematic diagram of an axial bridge indicating the configuration of the grids of the gages of FIG. 3A in accordance with an embodiment of the present disclosure. FIG. 3C is a schematic diagram of a bridge for total strain indicating the configuration of the grids of the gages of FIG. 3A in accordance with an embodiment of the present disclosure.

A structure 300 may be subject to forces in an axial direction, as indicated by arrow 301. To monitor and measure the forces and/or the response of the structure 300 to the forces, a first gage 302 and a second gage 304 may be applied to a surface 303 of structure 300. On a reverse side of the structure 300 may be located a third gage and a fourth gage (not shown), although it is understood that the second set of gages need not be used in all embodiments. The third gage may be substantially similar to the first gage 302 and oriented similarly, and the fourth gage may be substantially similar to the second gage 304 and oriented similarly. As will be appreciated by those of skill in the art, embodiments of the present disclosure may be applied to various structures upon which characteristic measurements are to be made, and particularly for applications where precision based on location may be important. Exemplary structures, although not limited thereto, include multiple transmission components, rotors, rotor controls, blades, transmissions, rods, shafts, etc. and/or parts thereof

Each of the gages 302, 304 includes two grids. The first gage 302 includes a first grid and associated tabs 308 and a second grid and associated tabs 310. The first grid 308 on the first gage 302 is orients substantially parallel to the axial direction 301 and may be wired into a full axial bridge configuration (see FIG. 3B) and may be configured to measure a characteristic of force. The second grid 310 on the first gage 302 is oriented substantially perpendicular to the axial direction 301 and may be wired directly into a data console (not shown) to produce or measure a characteristic of total strain or stress. The grids of the third gage on the reverse side of the structure 300 from the first grid 302 may be similarly configured and measure similar characteristics with the two grids therein.

The second gage 304 and the fourth gage may have similar constructions. For example, the second gage 304 may include a first grid and associated tabs 312 and a second grid and associated tabs 314. A grid on each of the second gage 304 and the fourth gage may be configured to provide measurements and input for the axial bridge, but may also provide a measurement of a different characteristic with the second grid on each of the second and fourth gages. Thus, in some embodiments, grids of the second gage 304 and the fourth gage may be measurement uncertainty (mu) or dummy gages for temperature compensation of the axial bridge that includes the first grids of the first gage 302 and the third gage.

Turning now to FIG. 3B, an electrical schematic (i.e. a Wheatstone bridge) representing a first circuit configured to measure a characteristic of the structure 300 using the gages of FIG. 3A is shown. First circuit 320 represents an axial bridge that employs a grid from each of the four gages on the structure 300. As shown, the grids of each of the gages are wired into a full axial bridge configuration. Thus, first resistor 322 is the first grid 308 of first gage 302, second resistor 324 is the first grid 312 of the second gage 304, third resistor 326 is the first grid of the third gage, and fourth resistor 328 is the first grid of the fourth gage. As configured and wired the circuit 320 can output a measurement such as force, provided the circuit is calibrated to such known external forces or loads on the component. In this configuration, the first grids of the first and third gages may react to tensile and compressive axial load on the structure 300 and the first grids of the second and fourth gages may be “mu” or dummy gages for temperature compensation of the first circuit 320.

Turning now to FIG. 3C, an electrical schematic representing a second circuit configured to measure a characteristic of the structure 300 using the gages of FIG. 3A is shown. Second circuit 330 includes a first resistor 332, a second resistor 334, a third resistor 336, and a fourth resistor 338. In this circuit the first resistor 332 may be formed by the second grid 310 of the first gage 302, and second, third, and fourth resistors 334, 336, 338 may be specific resistors of known resistance to complete the Wheatstone bridge inside a digital data console. With such a configuration, the circuit 330 may be configured to measure total strain at the position of the first gage 302. The configuration shown in FIG. 3C may be repeated for the third gage that is opposite the first gage 302 on structure 300. As such, a total strain measurement may be taken by the third gage, wherein the second grid of the third gage is configured as first resistor 332 in circuit 330.

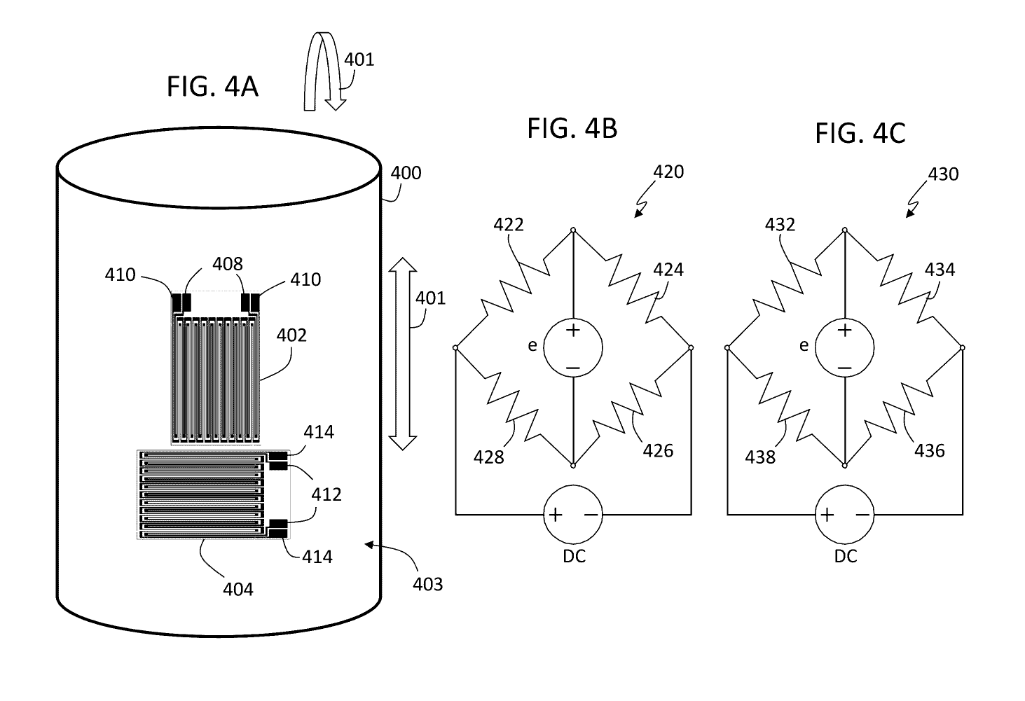

Turning now to FIGS. 4A-4C, an alternative application employing multiple gages in accordance with an exemplary embodiment of the present disclosure is shown. FIG. 4A shows a schematic illustration of a structure having multiple gages in accordance with an embodiment of the present disclosure applied thereon. FIG. 4B is a schematic diagram of an axial bridge indicating the configuration of the grids of the gages of FIG. 4A in accordance with an embodiment of the present disclosure. FIG. 4C is a schematic diagram of a half-bending bridge indicating the configuration of the grids of the gages of FIG. 4A in accordance with an embodiment of the present disclosure.

A structure 400 may be subject to bending moment or axial forces as indicated by arrows 401. To monitor and measure the forces and/or the response of the structure 400 to the forces, a first gage 402 and a second gage 404 may be applied to a surface 403 of structure 400. On a reverse side of the structure 400 may be located a third gage and a fourth gage. The third gage may be substantially similar to the first gage 402 and oriented similarly, and the fourth gage may be substantially similar to the second gage 404 and oriented similarly.

Each of the gages 402, 404 includes two grids. The first gage 402 includes a first grid and associated tabs 408 and a second grid and associated tabs 410. The first grid 408 on the first gage 402 is oriented substantially parallel to the axial direction 401 while perpendicular to the bending axis, and may be wired into a full axial bridge configuration (see FIG. 4B) and may be configured to measure a characteristic of force. The second grid 410 on the first gage 402 is oriented perpendicular to the axial direction 401 while parallel to the bending axis, and may be wired as part of a half-bending bridge configuration (see FIG. 4C) with a data console (not shown). The grids of the third gage on the reverse side of the structure 400 from the first grid 402 may be similarly configured and measure similar characteristics with the two grids therein. It will be appreciated by those of skill in the art that various configurations of gages may be configured to detect or take measurement simultaneously or at the same time. In other embodiments, one or more gages may take simultaneous measurements, while other gages are not used. Thus, in accordance with some embodiments, a plurality of measurements may be taken at a particular instance in time covering substantially the same areas of interest.

The second gage 404 and the fourth gage may have similar constructions. For example, the second gage 404 may include a first grid and associated tabs 412 and a second grid and associated tabs 414. A grid on each of the second gage 404 and the fourth gage may be configured to provide measurements and input for the axial bridge, but may also provide a measurement of a different characteristic with the second grid on each of the second and fourth gages. Thus, in some embodiments, grids of the second gage 404 and the fourth gage may be mu or dummy gages for temperature compensation of the axial bridge that includes the first grids of the first gage 402 and the third gage.

Turning now to FIG. 4B, an electrical schematic representing a first circuit configured to measure a characteristic of the structure 400 using the gages of FIG. 4A is shown. First circuit 420 represents an axial bridge that employs a grid from each of the four gages on the structure 400. As shown, the grids of each of the gages are wired into a full axial bridge configuration. Thus, first resistor 422 is the first grid 408 of first gage 402, second resistor 424 is the first grid 412 of the second gage 404, third resistor 426 is the first grid of the third gage, and fourth resistor 428 is the first grid of the fourth gage. As configured and wired the circuit 420 can output a calibrated measurement such as force. In this configuration, the first grids of the first and third gages may react to tensile and compressive axial load on the structure 400 and the first grids of the second and fourth gages may be “mu” or dummy gages for temperature compensation of the first circuit 420.

Turning now to FIG. 4C, an electrical schematic representing a second circuit configured to measure a characteristic of the structure 400 using the gages of FIG. 4A is shown. Second circuit 430 includes a first resistor 432, a second resistor 434, a third resistor 436, and a fourth resistor 438. In this circuit the first resistor 432 may be formed by the second grid 410 of the first gage 402 and the second resistor 434 may be formed by the second grid on the third gage. The third and fourth resistors 336, 338 may be specific resistors of known resistance to complete the Wheatstone bridge inside a digital data console. With such a configuration, the circuit 430 may be configured to measure a bending moment at the position of the first and third gages.

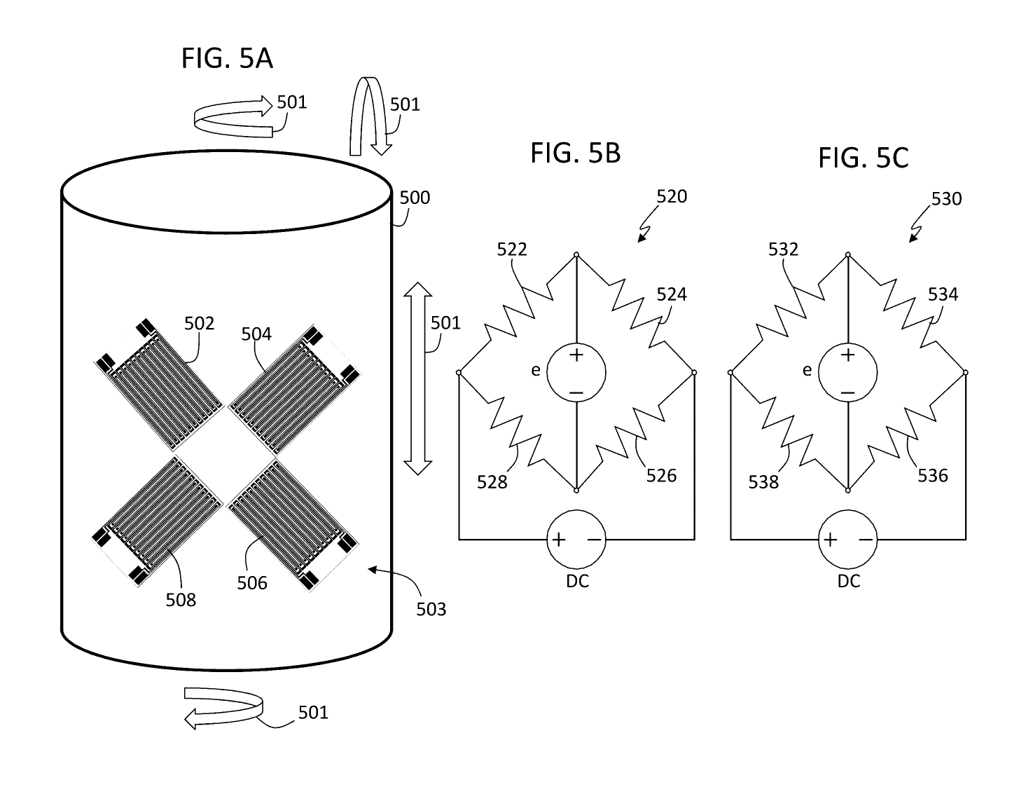

Turning now to FIGS. 5A-5C, an alternative application employing multiple gages in accordance with an exemplary embodiment of the present disclosure is shown. FIG. 5A shows a schematic illustration of a structure having multiple gages in accordance with an embodiment of the present disclosure applied thereon. FIG. 5B is a schematic diagram of a torsional bridge indicating the configuration of the grids of the gages of FIG. 5A in accordance with an embodiment of the present disclosure. FIG. 5C is a schematic diagram of a total strain bridge indicating the configuration of the grids of the gages of FIG. 5A in accordance with an embodiment of the present disclosure.

A structure 500 having a surface 503 may be subject to forces in multiple directions, as indicated by arrows 501, and thus it may be advantageous to monitor the structure 500. To monitor and measure the forces and/or the response of the structure 500 to the forces, a first gage 502, a second gage 504, a third gage 506, and a fourth gage 508 may be applied to the surface 503 of structure 500.

Each of the gages 502, 504, 506, 508 includes two grids, such as described above. The first grid of each of the gages 502, 504, 506, 508 may be wired into a torsion bridge configuration and may be configured to measure a characteristic of torsional moment. The second grid of each of the gages 502, 504, 506, 508 may be separately or independently wired as part of a total strain bridge configuration within a data console (not shown), such as described above.

Turning now to FIG. 5B, an electrical schematic representing a first circuit configured to measure a characteristic of the structure 500 using the gages of FIG. 5A is shown. First circuit 520 represents a torsion bridge that employs the first grid from each of the four gages 502, 504, 506, 508 on the structure 500. As shown, the grids of each of the gages are wired into a torsion bridge configuration. Thus, first resistor 522 is the first grid of first gage 502, second resistor 524 is the first grid of the second gage 504, third resistor 526 is the first grid of the third gage 506, and fourth resistor 528 is the first grid of the fourth gage 508. As configured and wired the circuit 520 can output a calibrated measurement such as torsional moment.

Turning now to FIG. 5C, an electrical schematic representing a second circuit configured to measure a characteristic of the structure 500 using the gages of FIG. 5A is shown. Second circuit 530 includes a first resistor 532, a second resistor 534, a third resistor 536, and a fourth resistor 538. In this circuit the first resistor 532 may be formed by the second grid of the first gage 502 and the second, third, and fourth resistors 534, 536, 538 may be specific resistors of known resistance to complete the Wheatstone bridge inside a digital data console. With such a configuration, the circuit 530 may be configured to measure a total stress or strain at the position of the first gage 502. Three additional circuits similar to second circuit 530 may be formed with the second grid of gages 504, 506, and 508 forming the first resistor, and the circuits being completed in a digital data console. Thus, four separate and distinct measurements of total stress or strain may be measured, each at a location of a gage.

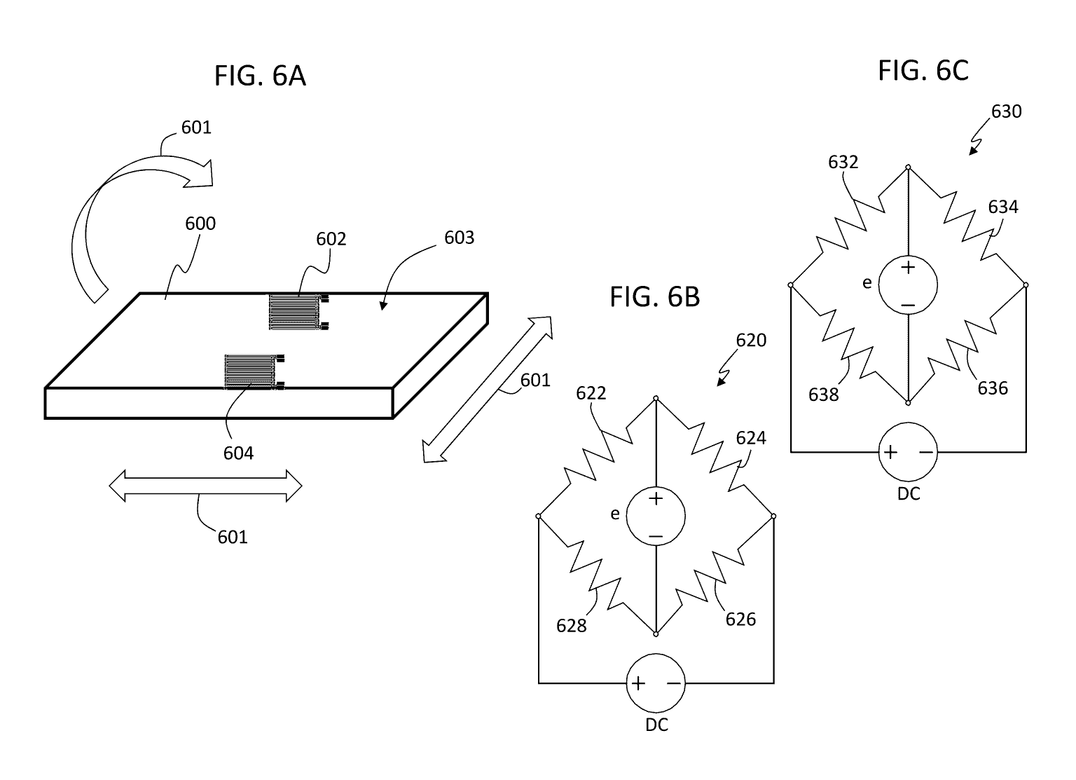

Turning now to FIGS. 6A-6C, an alternative application employing multiple gages in accordance with an exemplary embodiment of the present disclosure is shown. FIG. 6A shows a schematic illustration of a structure having multiple gages in accordance with an embodiment of the present disclosure applied thereon. FIG. 6B is a schematic diagram of a full bending bridge indicating the configuration of the grids of the gages of FIG. 6A in accordance with an embodiment of the present disclosure. FIG. 6C is a schematic diagram of a total strain bridge indicating the configuration of the grids of the gages of FIG. 6A in accordance with an embodiment of the present disclosure.

A structure 600 having a surface 603 may be subject to forces, e.g., shown as arrows 601, and thus it may be advantageous to monitor the structure 600. To monitor and measure the forces and/or the response of the structure 600 to the forces, a first gage 602 and a second gage 604 may be applied to the surface 603 of structure 600. Two additional gages, a third gage and a fourth gage, may be applied on the underside or opposite side of the structure 600.

Each of the gages includes two grids as described above. The first grid of each of the gages may be wired into a full bending bridge configuration and may be configured to measure a characteristic of bending moment. The second grid of each of the gages may be separately or independently wired as part of a total strain bridge configuration with a data console (not shown), such as described above.

Turning now to FIG. 6B, an electrical schematic representing a first circuit configured to measure a characteristic of the structure 600 using the gages of FIG. 6A is shown. First circuit 620 represents a full bending bridge that employs the first grid from each of the four gages on the structure 600. As shown, the first grids of each of the gages are wired into a full bending bridge configuration. Thus, first resistor 622 is the first grid of first gage 602, second resistor 624 is the first grid of the second gage 604, third resistor 626 is the first grid of the third gage, and fourth resistor 628 is the first grid of the fourth gage. As configured and wired the circuit 620 can output a calibrated measurement such as bending moment.

Turning now to FIG. 6C, an electrical schematic representing a second circuit configured to measure a characteristic of the structure 600 using the gages of FIG. 6A is shown. Second circuit 630 includes a first resistor 632, a second resistor 634, a third resistor 636, and a fourth resistor 638. In this circuit the first resistor 632 may be formed by the second grid of the first gage 602 and the second, third, and fourth resistors 634, 636, 638 may be specific resistors of known resistance to complete the Wheatstone bridge inside a digital data console. With such a configuration, the circuit 630 may be configured to measure a total stress or strain at the position of the first gage 602. Three additional circuits similar to second circuit 630 may be formed with the second grid of each of gages forming the first resistor, and the circuits being completed in a digital data console. Thus, four separate and distinct measurements of total stress or strain may be measured, each at a location of a gage.

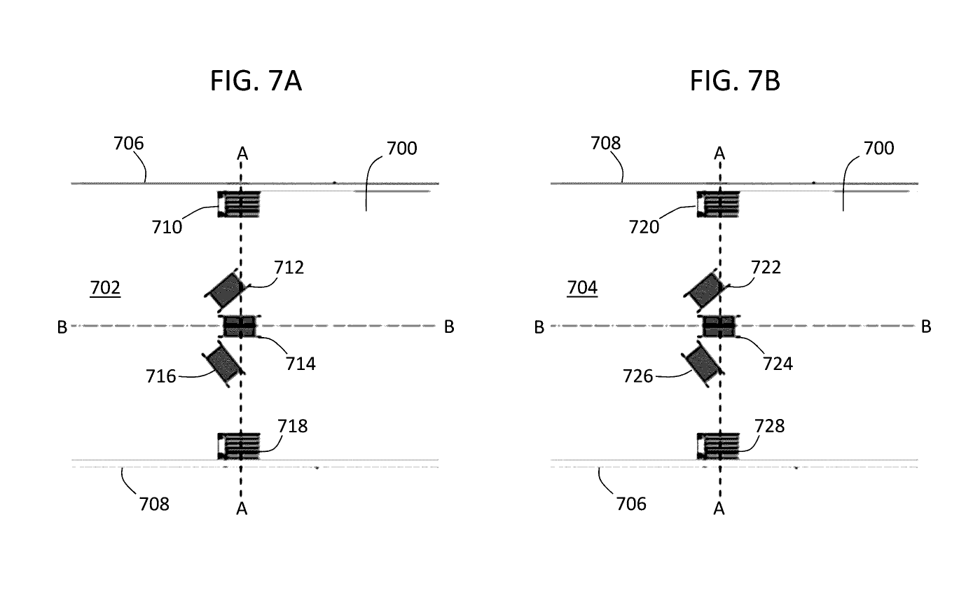

Turning now to FIGS. 7A and 7B, an exemplary application of gages in accordance with embodiments of the disclosure is shown. FIG. 7A shows a first side of a structure and FIG. 7B shows a second side of the same structure. For example, the structure may be a tail rotor flex beam with the inboard side shown in FIG. 7A and the outboard side shown in FIG. 7B. Although a particular example is provided herein, those of skill in the art will appreciate that the structure and configuration of the gages may be varied without departing from the scope of the disclosure, and the figures are merely provided for illustrative and explanatory purposes.

With reference to FIGS. 7A and 7B, a structure 700 has an inboard surface 702 and an outboard surface 704. Further, the structure 700 has a leading edge 706 and a trailing edge 708. The structure 700 has a rectangular cross section. Gages 710, 712, 714, 716, 718 are shown on the inboard surface 702 along a line A-A, which may be a radial station or point of interest along the structure 700, and a second line B-B may be a central axis of the structure 700. On the outboard surface 704, a similar group of gages 720, 722, 724, 726, 728 are configured on the structure 700. As such, gages 710, 712, 714, 716, 718 and 720, 722, 724, 726, 728 are installed or affixed at various radial stations on the inboard surface 702 and the outboard surface 704, respectively. In this exemplary embodiment, there are ten dual grid gauges similar to the gages described above. The plurality of gages enable multiple measurements and types thereof, including, for example, an edgewise bending full bridge, a torsion full bridge, a flatwise bending half bridge, and ten total strain measurements.

For example, as shown in FIG. 7A, gage 710 may have a first grid configured to form an edgewise bridge and a second grid configured to measure an inboard leading edge total strain at the same location. Gage 712 may have a first grid configured to form a torsion bridge and a second grid to measure an inboard 45° leading edge total strain at the same location. Gage 714 may have a first grid configured as a flatwise bending half bridge and a second grid configured to measure an inboard feathering axis total strain at the same location. Gage 716 may have a first grid form a torsion bridge and the second grid may measure an inboard 45° trailing edge total strain at the same location. Gage 718 may have a first grid configured as an edgewise bridge and a second grid configured to measure an inboard trailing edge total strain at the same location.

Similarly, as shown in FIG. 7B, gage 720 may have a first grid configured to form an edgewise bridge and a second grid configured to measure an outboard trailing edge total strain at the same location. Gage 722 may have a first grid configured to form a torsion bridge and a second grid to measure an outboard 45° trailing edge total strain at the same location. Gage 724 may have a first grid configured as a flatwise bending half bridge and a second grid configured to measure an outboard feathering axis total strain at the same location. Gage 726 may have a first grid form a torsion bridge and the second grid may measure an outboard 45° leading edge total strain at the same location. Gage 728 may have a first grid configured as an edgewise bridge and a second grid configured to measure an outboard leading edge total strain.

In the configuration of FIGS. 7A and 7B, gages 710, 718, 720, and 728 are installed on the outer edges (leading edge 706, trailing edge 708) of the structure 700. For each gage 710, 718, 720, and 728 the first grid of the gages is wired into a full edgewise bending bridge configuration, as described above. In some embodiments, the configuration may output calibrated engineering units of edgewise bending moment (e.g. in-lbs.). The second grid on gages 710, 718, 720, and 728 are separately wired directly into a data console (not shown) to produce output as total strain or stress (e.g. micro-in/in or psi). Advantageously, installing the edgewise bridge and the total strain gages at the same location using a dual grid gage in accordance with embodiments of the disclosure is that corner strain (i.e., the strain at highest loaded corner, which may often be a substantiating parameter) can be directly correlated with combined axial, torsion, edgewise, and flatwise bending in operation of the structure 700, such as in flight and on the ground, and it can validate analysis used to calculate the often derived parameter.

The gages 712, 716, 722, and 726, installed on the structure 700 at 45 degrees from the feathering axis (center line B-B of the structure 700) have the first grids wired into a full torsion bridge configuration, as described above. The calibrated output engineering units may be of torsional moment (e.g. in-lbs. or ft-lbs.). Alternately, in some embodiments, the torsion bridge could be calibrated to angular displacement with output in units of degrees. The second grids on 712, 716, 722, and 726 may be separately wired directly into the data console to produce output as total strain or stress (e.g. micro-in/in or psi). Alternatively, in some embodiments, the rosette of gages 712, 714, 716 on the inboard surface 702 or gages 722, 724, 726 on the outboard surface 704 can be used to calculate principal stress.

The gages 714, 724 installed on the feathering axis (center line B-B) of the structure 700 may be configured with the first grid wired into a flatwise (normal) bending half bridge configuration. In such configuration, the calibrated output engineering units may be flatwise moment (e.g. in-lbs.). The second grid on gages 714, 724 may be separately wired directly into the data console to produce output as total strain or stress (e.g. micro-in/in or psi). In some embodiments, the gages 714, 724 may react to axial load (produced by centrifugal force on a rotating structure), and they may also be wired into a half bridge and calibrated to axial load (or a full bridge with the addition of two dummy or mu gages added for temperature compensation). In other embodiments, as noted above, the rosette of gages 712, 714, 716 on the inboard surface 702 or gages 722, 724, 726 on the outboard surface 704 can be used to calculate principal stress.

Advantageously, embodiments of the present disclosure provide gages with dual grids thereon, enabling measurement of characteristics of a structure at a single location, without the need to offset the physical location of gages that are configured to measure different characteristics. Furthermore, advantageously, gages in accordance with various embodiments of the disclosure may include two grids covering essentially the same physical area, with the grids aligned in the same direction. The grids can be either overlaid or integrated within one layer and incorporate two separate measurement channels. Advantageously, this design allows for measuring both total strain or stress and a calibrated load or moment at one location using a single gage with two separate channels.

Furthermore, advantageously, gages with dual grids, as disclosed herein, may enable simultaneous measurement at a single point of interest, at a specific point or instance in time. Employed gages as disclosed herein enables simultaneous measurements such that both channels can be monitored at the same time and capture data from an exclusive and/or one-time event (e.g. test component fracture).

Furthermore, advantageously, dual grids gages in accordance with embodiments disclosed herein may run integrated (in between each other) or over laid, so that the output (i.e. strain) from each channel is from essentially the same surface area may be measured. Embodiments of the disclosure may be valuable in situations where there is not enough space to accommodate both a total strain gage and an axial bridge gage (such as on the neck of a rod end). Various embodiments of the disclosure may also be configured on a structure such as tail rotor flex beam, where both a corner strain measurement and a bending moment measurement may be required. Dual grid linear pattern gages in accordance with embodiments of the disclosure can also serve as backup gage/bridge channels on flight test aircraft, so that if a gage parameter fails, the backup gage parameter (i.e. same gage but the second grid thereof) can be used instead. This may reduce lost flight time, versus removing the aircraft component from the flight test aircraft and re-gaging, re-calibrating, and re-installing the component.

While the present disclosure has been described in detail in connection with only a limited number of embodiments, it should be readily understood that the present disclosure is not limited to such disclosed embodiments. Rather, embodiments of the present disclosure can be modified to incorporate any number of variations, alterations, substitutions, combinations, sub-combinations, or equivalent arrangements not heretofore described, but which are commensurate with the spirit and scope of the present disclosure. Additionally, while various embodiments of the present disclosure have been described, it is to be understood that aspects of the present disclosure may include only some of the described embodiments.

For example, although certain structures and/or configurations of gages thereon are described and shown herein, those of skill in the art will appreciate that other structures and/or configurations of gages may be employed without departing from the scope of the disclosure. Furthermore, although some exemplary dual-measurement configurations are disclosed herein regarding certain characteristics of a structure, those of skill in the art will appreciate that other characteristics may be measured and/or monitored without departing from the scope of the disclosure.

Accordingly, the present disclosure is not to be seen as limited by the foregoing description, but is only limited by the scope of the appended claims.

What is claimed is:

1. A system for measuring or monitoring characteristics of a structure comprising:
a first gage having a first grid and a second grid, the first and second grids configured to cover substantially the same area of a structure; and
a data console configured in electrical communication with each of the first grid and the second grid of the first gage,
wherein the first grid of the first gage is configured to measure a first characteristic of the structure and the second grid of the first gage is configured to measure a second characteristic of the structure.

2. The system of claim 1, further comprising a second gage having a first grid and a second grid configured to cover substantially the same area of the structure, the area of the second gage being different from the area of the first gage.

3. The system of claim 2, wherein the first grid of the second gage is configured to measure a third characteristic of the structure and the second grid of the second gage is configured to measure a forth characteristic of the structure.

4. The system of claim 3, wherein the first and third characteristics are the same.

5. The system of any of claims 2, wherein the first grid of the first gage and the first grid of the second gage are electrically connected to form a circuit.

6. The system of claim 1, wherein the data console is configured to form electrical circuits with the grids.

7. The system of claim 1, further comprising a plurality of additional gages, the additional gages each having a first grid and a second grid.

8. A method of measuring or monitoring characteristics of a structure, the method comprising:
disposing a first gage having a first grid and a second grid on a surface of a structure, the first and second grids configured to cover substantially the same area of a structure;
electrically connecting the first grid of the first gage into a first electrical circuit;
electrically connecting the second grid of the first gage into a second electrical circuit;
monitoring a first characteristic of the structure at a first area defined by the first gage, with the first electrical circuit; and
simultaneously monitoring a second characteristic of the structure at the first area with the second electrical circuit.

9. The method of claim 8, further comprising:
disposing a second gage at a second area, the second gage having a first grid and a second grid configured to cover the second area, the area of the second area being different from the first area;
electrically connecting the first grid of the second gage into a third electrical circuit; and
electrically connecting the second grid of the second gage into a fourth electrical circuit.

10. The method of claim 9, further comprising:
monitoring a third characteristic of the structure at the second area, with the third electrical circuit; and
monitoring a fourth characteristic of the structure at the second area with the fourth electrical circuit.

11. The method of claim 10, wherein the first and third characteristics are the same.

12. The method of any of claims 9, wherein the first grid of the first gage and the first grid of the second gage are electrically connected to form a circuit.

13. The method of any of claims 8, wherein the first grid of the first gage is configured as part of one of a torsion gage, a flatwise bending gage, and an edgewise bending gage.

14. The method of any of claims 8, further comprising:
disposing a plurality of additional gages on a surface of the structure wherein the additional gages each includes a first grid and a second grid.
